(19) United States
(12) Patent Application Publication
(10) Pub. No.: US 2022/0391972 A1
(43) Pub. Date: Dec. 8, 2022

(54) INFORMATION PROCESSING DEVICE, INFORMATION PROCESSING METHOD, AND INFORMATION PROCESSING PROGRAM

(71) Applicant: SONY GROUP CORPORATION, Tokyo (JP)

(72) Inventors: Yuuji TAKIMOTO, Kanagawa (JP); Yuki OKAMURA, Saitama (JP); Masahiro TAKAHASHI, Kanagawa (JP)

(73) Assignee: SONY GROUP CORPORATION, Tokyo (JP)

(21) Appl. No.: 17/775,729

(22) PCT Filed: Nov. 25, 2020
(86) PCT No.: PCT/JP2020/043811

§ 371 Date: May 10, 2022

(30) Foreign Application Priority Data
Dec. 3, 2019 (JP) 2019-218737

(51) Int. Cl. G06Q 40/02

(52) U.S. Cl. CPC G06Q 40/02

(57) ABSTRACT

An information processing device (1) includes a collection unit (31), an acquisition unit (32), and a proposal unit (34). The collection unit (31) collects income and expenditure information (42) regarding income and expenditure of a user. The acquisition unit (32) acquires promise information (44) of a promise regarding the income and expenditure made by the user with a virtual entity (AG) displayed on a display unit of a user terminal (100) possessed by the user. The proposal unit (34) proposes predetermined proposal information regarding the income and expenditure to the user based on the income and expenditure information (42) and the promise information (44).

### FIELD

The present disclosure relates to an information processing device, an information processing method, and an information processing program.

### BACKGROUND

Conventionally, for example, an information processing device that provides a household account book application for managing income and expenditure of a user has been known. In such a household account book application, a technology of giving advice regarding income and expenditure to a user based on a history of the income and expenditure of the user is used (see, for example, Patent Literature 1).

### CITATION LIST

### Patent Literature

Patent Literature 1: JP 2018-63536 A

### SUMMARY

### Technical Problem

However, in the related art, advice is merely given uniformly based on an income and expenditure history, general statistical data, or the like, and for example, in a case where a proposal such as advice for an expenditure that cannot be saved is made to the user, there is a possibility that the proposal is not accepted by the user. In addition, even though the advice is not accepted, the same advice may be given in the next month. As described above, in the related art, there is room for improvement in making a more appropriate proposal to the user.

Accordingly, the present disclosure proposes an information processing device, an information processing method, and an information processing program capable of making a more appropriate proposal to a user.

### Solution to Problem

An information processing device includes a collection unit, an acquisition unit, and a proposal unit. The collection unit collects income and expenditure information regarding income and expenditure of a user. The acquisition unit acquires promise information of a promise regarding the income and expenditure made by the user with a virtual entity displayed on a display unit of a user terminal possessed by the user. The proposal unit proposes predetermined proposal information regarding the income and expenditure to the user based on the income and expenditure information and the promise information.

### BRIEF DESCRIPTION OF DRAWINGS

FIG. 1 is a diagram illustrating an outline of an information processing method according to an embodiment.

FIG. 2 is a diagram illustrating an example of a configuration of an information processing system according to the embodiment.

FIG. 3 is a block diagram illustrating an example of a configuration of a user terminal according to the embodiment.

FIG. 4 is a block diagram illustrating an example of a configuration of an information processing device according to the embodiment.

FIG. 5 is a diagram illustrating an example of attribute information.

FIG. 6 is a diagram illustrating an example of income and expenditure information.

FIG. 7 is a diagram illustrating an example of promise information.

FIG. 8 is a diagram illustrating an example of personality information.

FIG. 9 is a diagram illustrating an example of preference information.

FIG. 10 is a sequence diagram (Part 1) illustrating an example of an operation between the user terminal and the information processing device.

FIG. 11 is a sequence diagram (Part 2) illustrating the example of the operation between the user terminal and the information processing device.

FIG. 12 is a flowchart illustrating a processing procedure of processing performed by the information processing device according to the embodiment.

FIG. 13 is a block diagram illustrating an example of a hardware configuration of the information processing device according to the present embodiment.

### DESCRIPTION OF EMBODIMENTS

Hereinafter, embodiments of the present disclosure will be described in detail with reference to the drawings. Note that, in each of the following embodiments, the same reference signs denote the same portions, and an overlapping description will be omitted.

Further, in the present specification and the drawings, a plurality of components having substantially the same functional configuration may be distinguished by adding different numbers after the same reference signs. However, in a case where it is not particularly necessary to distinguish each of the plurality of components having substantially the same functional configuration, only the same reference sign is given.

Further, the present disclosure will be described in the following order.

1. Embodiment

1-1. Outline of Information Processing Method According to Embodiment

1-2. Configuration of Information Processing System According to Embodiment

1-3. Configuration of User Terminal According to Embodiment

1-4. Configuration of Information Processing Device According to Embodiment

1-5. Hardware Configuration Example

2. Modified Example

3. Conclusion

### 1. Embodiment

<1-1. Outline of Information Processing Method According to Embodiment>

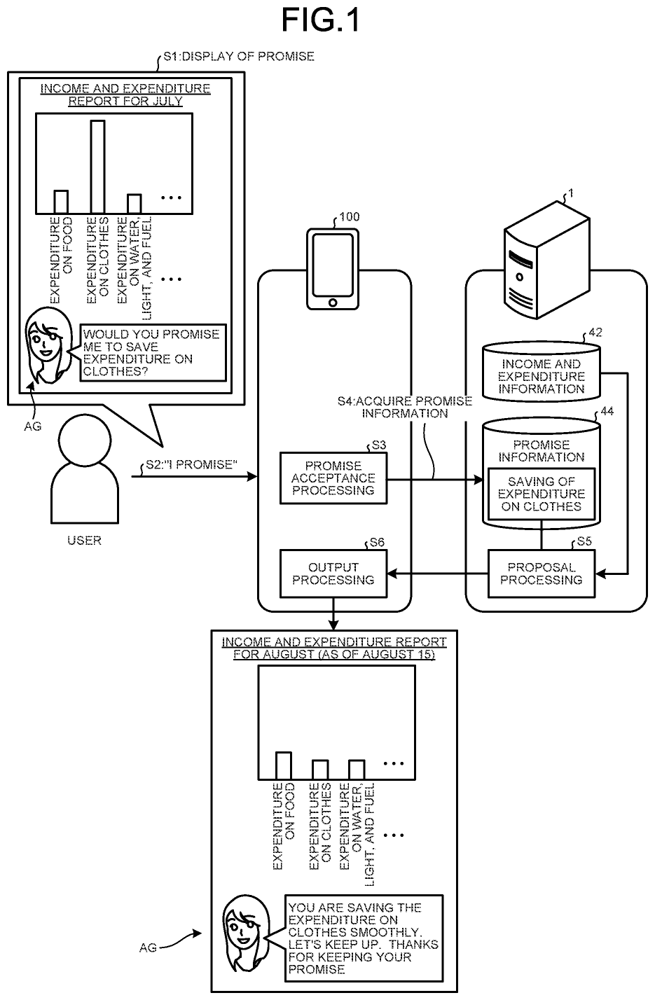

FIG. 1 is a diagram illustrating an outline of an information processing method according to an embodiment. FIG. 1 illustrates information processing performed by an information processing device 1 that executes an information processing method according to an embodiment and a user terminal 100 possessed by a user.

As illustrated in FIG. 1, it is assumed that the information processing device 1 according to the embodiment collects and stores income and expenditure information 42 regarding income and expenditure of the user in advance. The income and expenditure information 42 is information regarding the income and expenditure of the user. Note that a content of the income and expenditure information 42 and a collection method thereof will be described in detail later.

The information processing device 1 according to the embodiment has a function of generating an income and expenditure report regarding the income and expenditure of the user based on the income and expenditure information 42, and can display the generated income and expenditure report on the user terminal 100.

The example illustrated in FIG. 1 illustrates an example in which an income and expenditure report for July generated by the information processing device 1 is displayed on a display unit of the user terminal 100. Specifically, the income and expenditure report of expenditure on food, expenditure on clothes, and expenditure on water, light, and fuel as an income and expenditure type is illustrated. Furthermore, an agent AG, which is a virtual entity, is displayed on the display unit, and the information processing device 1 notifies the user of information such as advice regarding the income and expenditure by voice or text via the agent AG. Note that the virtual entity is a virtual entity that has a conversation (for example, makes a promise or the like) with the user. Note that, in a case where the amount of information (income and expenditure report, proposal information, or the like) displayed on the display unit of the user terminal 100 is a predetermined amount or more, the proposal information may be provided by voice or the like in a state where the agent AG temporarily disappears from a screen. Furthermore, in the user terminal 100, the agent AG may be set internally so that the agent AG does not appear on the screen.

Here, conventionally, in a case where advice is given to the user, the advice has been given based on an income and expenditure history. For this reason, conventionally, only uniform advice is given, and it is not possible to consider, for example, a situation in which the user cannot save (does not want to save) expenditure of a specific income and expenditure type. Therefore, the user feels that it is difficult to accept the advice for the specific income and expenditure type, and there is a possibility that the advice is not accepted. As described above, in the related art, there is room for improvement in making a more appropriate proposal to the user.

Therefore, in the information processing method according to the embodiment, a predetermined promise regarding the income and expenditure is made between the user and the agent AG, and advice regarding the income and expenditure or the like is given based on the promise. Note that, although details will be described later, advice can be given based on information regarding a preference of the user, in addition to the promise of the user.

Specifically, first, the information processing device 1 displays a promise for saving the expenditure on clothes via the agent AG together with the income and expenditure report for July (Step S1). In FIG. 1, the agent AG notifies of the proposal information “Would you promise me to save expenditure on clothes?” by text and voice. However, for example, a notification of the proposal information may be made only by voice.

Note that, in FIG. 1, a target of the promise is the expenditure on clothes that is equal to or larger than a predetermined threshold, but the target can be determined based on the preference of the user, which will be described in detail later. Furthermore, the notification of the proposal information illustrated in FIG. 1 can be made with a content or an expression method compatible with a personality of the user, which will also be described in detail later.

Then, it is assumed that the user inputs (voice or text) “I promise” in response to the displayed promise (Step S2). The user terminal 100 performs promise reception processing based on the information regarding “I promise” (Step S3). For example, the user terminal 100 determines whether or not the input of “I promise” indicates that the promise is made by voice analysis or language analysis, and transmits the determination result to the information processing device 1. Alternatively, the user terminal 100 may transmit “I promise” as it is to the information processing device 1, and the information processing device 1 may perform the voice analysis or language analysis. Note that the present disclosure is not limited to a case of determining whether or not the promise has been made, and for example, a level of confidence in the promise or the like can be used. The level of confidence can be estimated based on, for example, an expression of the user analyzed based on a camera image, a length of time until a response to the proposal information is made, and the like. Furthermore, for example, a content of a promise including a category, an amount, and a timing, such as “saving expenditure on food”, “saving o yen”, or “saving money in next month”, may be determined.

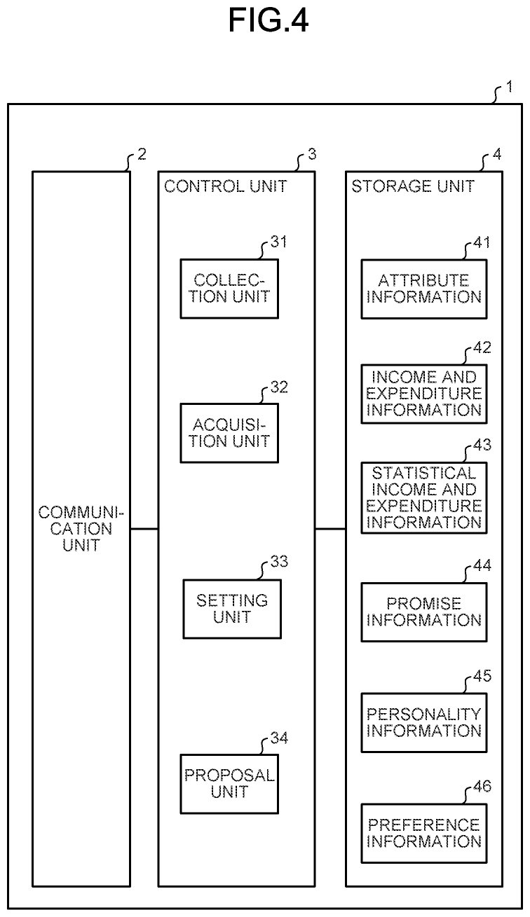

Then, the information processing device 1 acquires promise information 44 based on the information received from the user terminal 100 and the information regarding the displayed promise (Step S4) and stores the promise information 44 in a storage unit 4 (see FIG. 4). In FIG. 1, information regarding saving of the expenditure on clothes (for example, saving o o yen in next month) is stored as the promise information 44.

Then, the information processing device 1 performs proposal processing of proposing predetermined proposal information regarding the income and expenditure to the user at a predetermined timing based on the stored income and expenditure information 42 and promise information 44 (Step S5). Then, the user terminal 100 performs output processing of outputting the proposal information acquired from the information processing device 1 via the display unit (Step S6). In FIG. 1, proposal information based on an income and expenditure report for August up to August 15 is proposed. Specifically, proposal information “You are saving the expenditure on clothes smoothly. Let's keep up. Thanks for keeping your promise.” is proposed.

Note that, in a case where the user does not make the promise displayed together with the income and expenditure report for July in Step S1 due to circumstances that the user does not want to save the expenditure on clothes and the like, the information processing device 1 does not propose the proposal information regarding the expenditure on clothes even in a case where the expenditure on clothes exceeds a threshold, which normally causes proposal of the proposal information.

That is, in the information processing method according to the embodiment, for example, by taking into account a circumstance that the user cannot save (does not want to save) the expenditure on clothes as the promise information 44, it is possible to propose the proposal information that is easy for the user to accept and to prevent the proposal information that is difficult for the user to accept. Therefore, with the information processing method according to the embodiment, a more appropriate proposal can be made to the user. Note that when the level of confidence in the promise is low, a target amount to be saved may be corrected (reduced). Alternatively, correction of a target (a content of the proposal information) may be changed according to the level of confidence. For example, in a case where the level of confidence in the promise is low and the user has failed to keep the promise, the target amount to be saved may be increased to a larger extent, and in a case where the level of confidence is high and the user has failed to keep the promise, the target amount to be saved may be increased to a smaller extent.

<1-2. Configuration of Information Processing System S According to Embodiment>

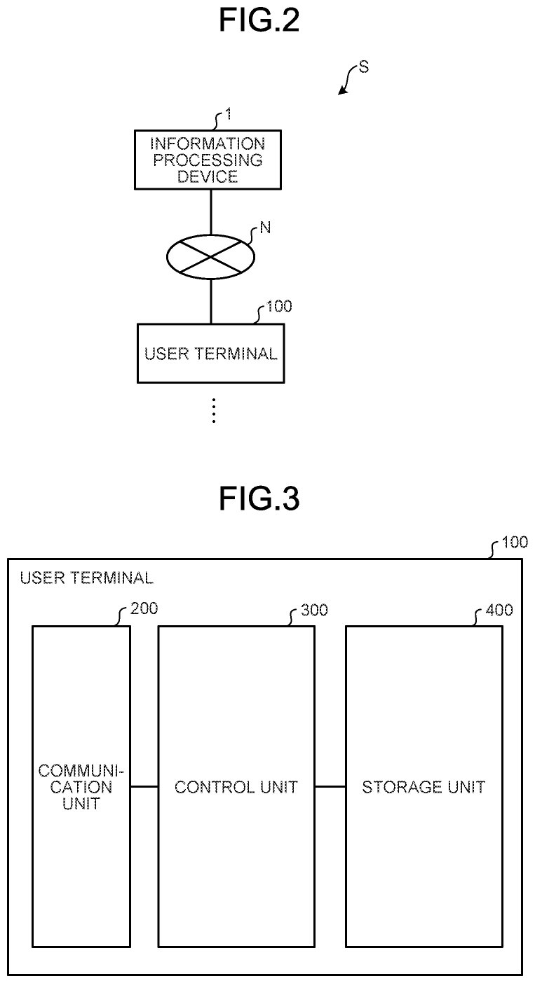

Next, a configuration of the information processing system S according to the embodiment will be described with reference to FIG. 2. FIG. 2 is a diagram illustrating an example of the configuration of the information processing system S according to the embodiment.

As illustrated in FIG. 2, the information processing system S includes the information processing device 1 and a plurality of user terminals 100. The information processing device 1 and the plurality of user terminals 100 are connected via a network N. The network N is a communication network such as a local area network (LAN), a wide area network (WAN), a telephone network (a mobile telephone network, a fixed telephone network, or the like), a regional Internet protocol (IP) network, or the Internet. The network N may include a wired network or a wireless network.

The information processing device 1 is, for example, a server device that provides various services to the user terminal 100. For example, the information processing device 1 provides an application for managing the income and expenditure to the user terminal 100.

The user terminal 100 is a terminal device used by the user. The user terminal 100 is, for example, a smartphone, a desktop personal computer (PC), a notebook PC, a tablet terminal, a mobile phone, a personal digital assistant (PDA), a wearable device, or the like. The user terminal 100 makes various requests to the information processing device 1 and acquires various types of information from the information processing device 1 according to an operation (voice input, camera image, or text input) by the user.

<1-3. Configuration of User Terminal 100 According to Embodiment>

Next, an example of a configuration of the user terminal 100 according to the embodiment will be described with reference to FIG. 3. FIG. 3 is a block diagram illustrating the example of the configuration of the user terminal 100 according to the embodiment. As illustrated in FIG. 3, the user terminal 100 according to the embodiment includes a communication unit 200, a control unit 300, and a storage unit 400. Note that the user terminal 100 may include an input unit (for example, a keyboard, a mouse, a microphone, or a camera) that receives various operations from the user, and an output unit (for example, a liquid crystal display, a speaker, or the like) that outputs various types of information.

The communication unit 200 is implemented by, for example, a network interface card (NIC) or the like. Then, the communication unit 200 is connected to the predetermined network N in a wired or wireless manner, and transmits and receives information to and from the information processing device 1. Furthermore, the communication unit 200 may transmit and receive information to and from another user terminal 100.

The control unit 300 is implemented by, for example, a central processing unit (CPU), a micro processing unit (MPU), or the like executing a program stored in the user terminal 100 with a random access memory (RAM) or the like as a work area. Further, the control unit 300 is a controller and is implemented by, for example, an integrated circuit such as an application specific integrated circuit (ASIC) or a field programmable gate array (FPGA).

Note that the control unit 300 may be configured to execute some or all of the functions executed by a control unit 3 of the information processing device 1 as described later.

The storage unit 400 is implemented by, for example, a semiconductor memory element such as a RAM or a flash memory, or a storage device such as a hard disk or an optical disk. Note that the storage unit 400 may be configured to store a part or all of information stored in the storage unit 4 of the information processing device 1 as described later.

<1-4. Configuration of Information Processing Device 1 According to Embodiment>

Next, an example of a configuration of the information processing device 1 according to the embodiment will be described with reference to FIG. 4. FIG. 4 is a block diagram illustrating the example of the configuration of the information processing device 1 according to the embodiment. As illustrated in FIG. 4, the information processing device 1 according to the embodiment includes a communication unit 2, the control unit 3, and the storage unit 4.

The communication unit 2 is implemented by, for example, an NIC or the like. Then, the communication unit 2 is connected to the predetermined network N in a wired or wireless manner, and transmits and receives information to and from each of the plurality of user terminals 100.

The control unit 3 is implemented by, for example, a CPU, an MPU, or the like executing a program stored in the information processing device 1 with a RAM or the like as a work area. Further, the control unit 3 is a controller and is implemented by, for example, an integrated circuit such as an application specific integrated circuit (ASIC) or a field programmable gate array (FPGA).

As illustrated in FIG. 4, the control unit 3 includes a collection unit 31, an acquisition unit 32, a setting unit 33, and a proposal unit 34, and implements or executes functions and actions of information processing as described below. Note that an internal configuration of the control unit 3 is not limited to the configuration illustrated in FIG. 4, and may be another configuration as long as the communication processing as described later is performed. For example, the control unit 3 may be configured to execute some or all of the functions executed by the control unit 300 of the user terminal 100 described above.

The storage unit 4 is implemented by, for example, a semiconductor memory element such as a RAM or a flash memory, or a storage device such as a hard disk or an optical disk. Note that the storage unit 4 may be configured to store a part or all of the information stored in the storage unit 400 of the user terminal 100 described above.

The storage unit 4 is implemented by, for example, a semiconductor memory element such as a RAM or a flash memory, or a storage device such as a hard disk or an optical disk. As illustrated in FIG. 4, the storage unit 4 according to the embodiment stores attribute information 41, the income and expenditure information 42, statistical income and expenditure information 43, the promise information 44, personality information 45, and preference information 46.

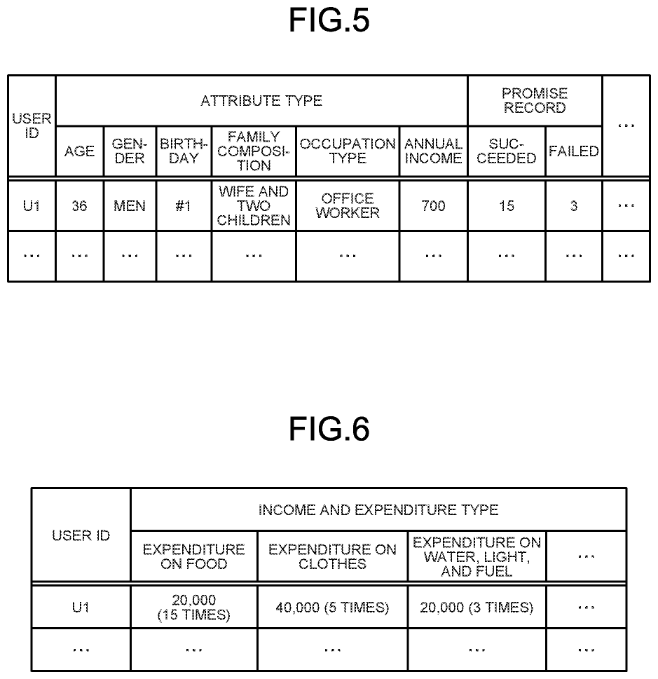

Hereinafter, each piece of information stored in the storage unit 4 will be described with reference to FIGS. 5 to 9.

FIG. 5 is a diagram illustrating an example of the attribute information 41. The attribute information 41 is information including information regarding an attribute of the user. The attribute information 41 may be acquired from the user in advance, or may be estimated from context of input and output of information by voice, text, or the like. For example, as illustrated in FIG. 5, the attribute information 41 includes items such as “user ID”, “attribute type”, and “promise record”.

The “user ID” is identification information for identifying the user. The “attribute type” is information regarding the type of attribute of the user. FIG. 5 illustrates, as an example of the “attribute type”, items such as “age”, “gender”, “birthday”, “family composition”, “occupation type”, and “annual income”. The “promise record” is information regarding a record of a promise made by the user to be described later.

FIG. 6 is a diagram illustrating an example of the income and expenditure information 42. The income and expenditure information 42 is information including information regarding the income and expenditure of the user. The income and expenditure information 42 may be input by the user, for example, or the income and expenditure information 42 may be acquired based on payment information acquired from a credit card company or the like. Furthermore, in a case where the user terminal 100 has an electronic money payment function, the income and expenditure information 42 may be acquired based on electronic money payment information.

For example, as illustrated in FIG. 6, the income and expenditure information 42 includes items such as “user ID” and “income and expenditure type”.

The “user ID” is identification information for identifying the user. The “income and expenditure type” is information regarding the type of the income and expenditure of the user. FIG. 6 illustrates, as an example of the “income and expenditure type”, items such as “expenditure on food”, “expenditure on clothes”, and “expenditure on water, light, and fuel”. Note that the “income and expenditure type” may be determined in advance or may be uniquely set by the user.

In the example illustrated in FIG. 6, the “expenditure on food” of the income and expenditure type of the user identified by a user ID “U1” is “20,000 (15 times)”. This indicates that there are 15 transactions related to the expenditure on food in a predetermined period (for example, one month), and the total amount of the 15 transactions is 20,000.

The statistical income and expenditure information 43 is statistical income and expenditure information generated based on the income and expenditure information of other users. Specifically, the statistical income and expenditure information 43 includes statistical information for each income and expenditure type and for each attribute type. For example, the statistical income and expenditure information 43 includes information regarding the expenditure on food (for example, an average value) of other users having attributes such as an age of thirties, male, married (wife and two children), and annual income of 7 million yen, for one month.

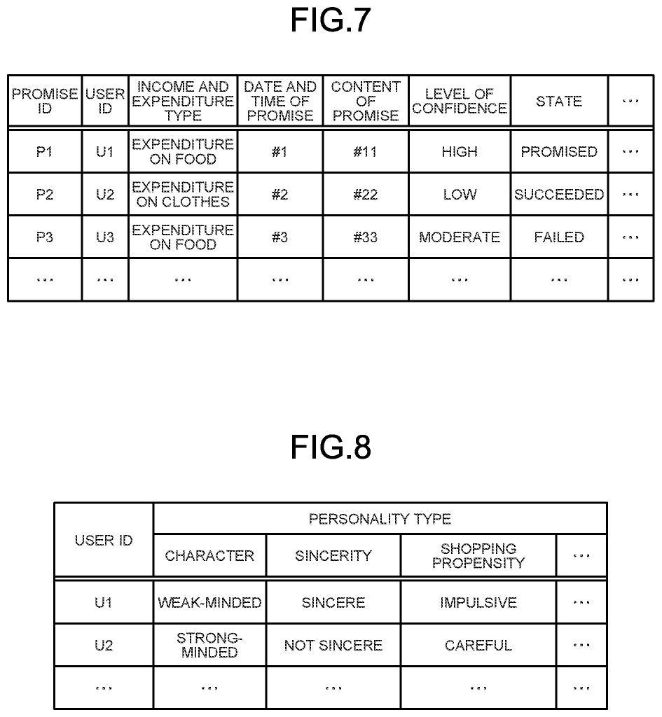

FIG. 7 is a diagram illustrating an example of the promise information 44. The promise information 44 is information including information indicating that the user has made a promise regarding the income and expenditure with the agent. As illustrated in FIG. 7, the promise information 44 includes items such as “promise ID”, “user ID”, “income and expenditure type”, “date and time of promise”, “content of promise”, “level of confidence”, and “state”.

The “promise ID” is identification information for identifying each promise made by the user. The “user ID” is identification information for identifying the user. The “income and expenditure type” is information indicating the above-described income and expenditure type. The “date and time of promise” is information indicating the date and time when the user has made the promise with the agent. The “content of promise” is information indicating a content of the promise made by the user with the agent. The “level of confidence” is confidence information indicating the level of confidence of the user in the promise. Although details will be described later, the “level of confidence” can be calculated by analyzing voice input when the user makes the promise. In FIG. 7, the level of confidence is indicated as high, moderate, or low, but the present invention is not limited thereto, and the level of confidence may be scored.

The “state” is a current promise state. For example, “promised” indicates that the promise made by the user is continuing, and “succeeded” and “failed” indicate that the promise has been completed and indicate whether or not the promise has been kept (succeeded) or broken (failed). Note that the “state” illustrated in FIG. 7 is an example, and for example, the “state” may be indicated as highly confident and succeeded (or failed), or less confident and failed (or succeeded). In addition, the “succeeded” may include “succeeded with margin” indicating that the amount of saved money is higher than a target amount of saved money by a predetermined value or more, “barely succeeded” indicating that the amount of saved money is higher than the target amount of saved money by less than the predetermined value, and the like.

FIG. 8 is a diagram illustrating an example of the personality information 45. The personality information 45 is information including information regarding the personality of the user. As illustrated in FIG. 8, the personality information 45 includes items such as “user ID” and “personality type”.

The “user ID” is identification information for identifying the user. The “personality type” is information indicating the type of personality of the user. FIG. 8 illustrates, as an example of the “personality type”, items such as “character”, “sincerity”, and “shopping propensity”. Note that a predetermined score may be calculated for each personality type. For example, the “character” may be scored so that the more the user is strong-minded, the higher the value.

Note that the personality information 45 may be acquired from the user in advance by, for example, a questionnaire or the like, or may be estimated by a machine learning model. For example, the personality information 45 may be an output score of a model (for example, a regression model) generated by machine learning using predetermined information. Note that the predetermined information includes, for example, information obtained from a questionnaire answer result, information obtained from a conversation between the user and the agent AG, information (a camera image or the like) obtained by a sensor included in the user terminal 100, and the like.

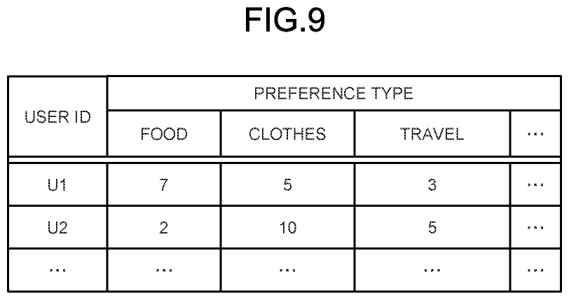

FIG. 9 is a diagram illustrating an example of the preference information 46. The preference information 46 is information including information regarding the preference of the user. The preference information 46 may be acquired from the user in advance by, for example, a questionnaire or the like, and the personality may be estimated based on a reaction of the user to the proposal information to be described later.

As illustrated in FIG. 9, the preference information 46 includes items such as “user ID” and “preference type”. The “user ID” is identification information for identifying the user. The “preference type” is information indicating the type of preference of the user. FIG. 9 illustrates, as an example of the “preference type”, items such as “food”, “clothes”, and “travel”. In addition, in FIG. 9, the degree of preference indicating how much the user prefers each preference type is classified into 10 levels, and the higher the level, the higher the degree of preference (more preferred).

That is, in the example illustrated in FIG. 9, the user identified by the user ID “U1” prefers food the most among the preference types. Note that, in FIG. 9, the degree of preference is scored, but may also be indicated as, for example, “like”, “not like”, or the like.

Next, each function (the collection unit 31, the acquisition unit 32, the setting unit 33, and the proposal unit 34) of the control unit 3 in the information processing device 1 will be described in detail.

The collection unit 31 acquires the income and expenditure information 42 regarding the income and expenditure of the user. For example, the collection unit 31 acquires information regarding a credit card or a bank account possessed by the user to collect transaction information such as credit card payment, transfer or withdrawal in the bank account as the income and expenditure information 42.

Furthermore, in a case where the user terminal 100 has an electronic money payment function, the collection unit 31 acquires information regarding electronic money payment as the income and expenditure information 42. In addition, the collection unit 31 may acquire the income and expenditure information 42 by manual input by the user.

Note that the income and expenditure information 42 collected by the collection unit 31 includes information regarding the amount of money (the expenditure on food “20,000 yen” illustrated in FIG. 6) and the number of transactions (the expenditure on food “15 times” illustrated in FIG. 6) for each income and expenditure type described above, but may also include other information. For example, the income and expenditure information 42 may include information regarding a shopping content (an article type related to the income and expenditure), shopping date and time (date and time when the income and expenditure has occurred), the number of times of shopping (the number of times of occurrence of the income and expenditure), and a shopping place (a place where the income and expenditure has occurred, and a shopping amount (an income) and expenditure amount).

Furthermore, the income and expenditure information 42 may further include information such as a difference in income and expenditure information 42 between the present month and the previous month (or another month) That is, the income and expenditure information 42 may include information regarding a difference between the income and expenditure information 42 in the current predetermined period and the income and expenditure information 42 in the past predetermined period.

The collection unit 31 stores the collected income and expenditure information 42 in the storage unit 4.

The acquisition unit 32 acquires various types of information regarding the user. Specifically, the acquisition unit 32 acquires the attribute information 41, the promise information 44, the personality information 45, the preference information 46, and the like, and stores them in the storage unit 4.

For example, the acquisition unit 32 displays a questionnaire for acquiring the above-described information on the user terminal 100, and acquires the attribute information 41, the promise information 44, the personality information 45, and the preference information 46 based on an answer of the user to the questionnaire.

Furthermore, the acquisition unit 32 may estimate the attribute information 41, the promise information 44, the personality information 45, and the preference information 46 based on the conversation between the user and the agent AG. For example, the acquisition unit 32 makes a question regarding how to spend money such as “Do you like saving money?” via the agent AG, and acquires the personality information 45 indicating that the user has a habit of wasting money in a case where the user makes an answer “I don't like it”, for example.

Furthermore, the acquisition unit 32 may acquire a reaction of the user to the proposal information proposed by the proposal unit 34 to be described later, and estimate the personality of the user based on the acquired reaction. The reaction of the user is detected by, for example, various sensors such as a camera and a microphone of the user terminal 100. For example, in a case where the user actually saves money in response to the proposal information with a strict tone such as “Save the expenditure on food”, the acquisition unit 32 estimates that the user is resistant to discipline. On the other hand, in a case where the user does not actually save money regardless of the proposal information with a strict tone or the user looks awkward in the camera image of the user terminal 100 due to the proposal information with a strict tone, the acquisition unit 32 estimates that the user does not like discipline.

In addition, the acquisition unit 32 acquires the promise information 44 indicating that the user promises to carry out a proposal indicated by the proposal information proposed by the proposal unit 34 to be described later. Specifically, the acquisition unit 32 morphologically analyzes language information obtained by analyzing the voice or text of the user input via the user terminal 100, and in a case where a specific keyword such as “I promise” or the like is detected, the acquisition unit 32 acquires (generates) the promise information 44 based on the proposal information that is being displayed on the user terminal 100, stores the promise information 44 in the storage unit 4.

At this time, the acquisition unit 32 acquires (generates) the confidence information indicating the level of confidence of the user in the promise, the level of confidence being estimated based on information input via the user terminal 100. Specifically, the acquisition unit 32 generates the confidence information based on a specific keyword such as “absolutely”, “probably”, or “anxious”. Note that, when generating the confidence information, voice tone information may be acquired and used.

In addition, the acquisition unit 32 acquires record information (the promise record illustrated in FIG. 5) regarding a record of success and failure for the past promise information 44. Specifically, in a case where the user has kept the promise indicated by the promise information 44, the acquisition unit 32 acquires the record information indicating success, updates the “state” in FIG. 7 from “promised” to “succeeded”, and counts up “succeeded” of the “promise record” in FIG. 5. On the other hand, in a case where the user has not kept the promise indicated by the promise information 44, the acquisition unit 32 acquires the record information indicating failure, updates the “state” in FIG. 7 from “promised” to “failed”, and counts up “failed” of the “promise record” in FIG. 5. Note that the “promise record” in FIG. 5 may be divided into a record of the promise for the proposal information with a strict tone and a record of the promise for the proposal information with a gentle tone. Alternatively, a case of not making the promise may be included. In addition, instead of being divided into “succeeded” and “failed”, the record may be subdivided into “highly confident and succeeded”, “less confident and failed”, “barely succeeded”, “succeeded with margin”, and the like.

Furthermore, the acquisition unit 32 may acquire the preference information 46 based on the reaction of the user to the proposal information regarding the specific income and expenditure type proposed by the proposal unit 34 to be described later. Specifically, it is assumed that, in a case where the acquisition unit 32 proposes the proposal information such as “The expenditure on clothes is high. Would you promise me to save the expenditure on clothes next month?”, the user makes an answer “I can't promise you because I like clothes”. In such a case, when a specific keyword such as “I like clothes” is detected, the acquisition unit 32 acquires (generates) the preference information 46 indicating that the user likes clothes, and stores the preference information 46 in the storage unit 4.

The setting unit 33 sets various parameters related to the agent AG which is the virtual entity. For example, the setting unit 33 sets parameters such as a personality, gender, appearance, language (Japanese, English, or the like), accent, intonation, and background (for example, a place in or outside a house) of the agent AG.

For example, the setting unit 33 sets a value selected by the user from a plurality of options as the parameter of the agent AG for each parameter described above. Furthermore, the setting unit 33 may automatically set each parameter based on answers to a questionnaire performed by the acquisition unit 32 to obtain various types of information.

The proposal unit 34 proposes various types of proposal information regarding the income and expenditure of the user. For example, the proposal unit 34 proposes the proposal information based on the attribute information 41, the income and expenditure information 42, the statistical income and expenditure information 43, the promise information 44, the personality information 45, the preference information 46, and the parameter of the agent AG set by the setting unit 33. For example, the proposal unit 34 determines a content and an expression method of the proposal information based on the various types of information described above.

Specifically, in a case where a request to view an income and expenditure report for a predetermined period (for example, the present month or the like) is received from the user via the user terminal 100, the proposal unit 34 first calculates the income and expenditure of each income and expenditure type in the predetermined period based on the income and expenditure information 42.

Then, the proposal unit 34 selects another user having an attribute similar to the attribute of the user from the statistical income and expenditure information 43 stored in the storage unit 4, and compares the income and expenditure of each income and expenditure type of the another user with the income and expenditure of each income and expenditure type calculated above. Then, the proposal unit 34 determines, as a proposal target (promise target) of the proposal information, an income and expenditure type in which a difference in income and expenditure, specifically, a difference in expenditure is equal to or larger than a predetermined threshold as a result of the comparison. That is, the proposal unit 34 performs the comparison between the user and another user having an attribute similar to that of the user, and determines, as the proposal target, an income and expenditure type of which the expenditure is prominently high.

Subsequently, the proposal unit 34 determines whether or not to propose the proposal information based on the preference information 46 for the income and expenditure type determined as the proposal target. For example, in a case where the income and expenditure type that is the proposal target is the expenditure on clothes and the preference information 46 indicates that the user likes clothes, the proposal unit 34 does not propose the proposal information for the expenditure on clothes that is the proposal target. That is, the proposal unit 34 prohibits the proposal of the proposal information for the income and expenditure type corresponding to the preference information 46 among the income and expenditure types included in the income and expenditure information 42. Alternatively, instead of completely prohibiting the proposal of the proposal information, the threshold may be loosened so as to determine whether or not to propose the proposal information even when the expenditure is more than those of other households to some extent. Furthermore, even in a case where the user likes clothes, when the expenditure is excessively high, the proposal information may be proposed. Furthermore, conversely, in a case where the expenditure on clothes that the user likes is reduced compared to other households, there is a possibility that the user no longer likes clothes. Therefore, for example, the user may be asked a question, and in a case where the user no longer likes clothes, the prohibition of the proposal may be released by excluding the corresponding income and expenditure type from the preference information 46.

Then, the proposal unit 34 determines, as the proposal target, an income and expenditure type other than the income and expenditure type for which the proposal is prohibited.

For example, the proposal unit 34 determines, as the proposal target, an income and expenditure type of which the expenditure is the second highest following the income and expenditure type for which the proposal is prohibited. That is, the proposal unit 34 determines an income and expenditure type for which the proposal information is to be proposed based on the preference information 46 among the income and expenditure types included in the income and expenditure information 42. In the income and expenditure of the income and expenditure type in such a case, the difference in expenditure may be less than the predetermined threshold in the above comparison result.

In addition, the proposal unit 34 preferably excludes the income and expenditure type associated with the income and expenditure type for which the proposal is prohibited from the proposal target. For example, in a case of a person who likes to eat out at various places, expenditure on transportation is required to move to the place. Therefore, in such a case, the proposal unit 34 excludes the expenditure on transportation from the proposal target in addition to the expenditure on food. Alternatively, the threshold used to determine to propose the proposal information may be loosened.

Subsequently, the proposal unit 34 determines the content and the expression method of the proposal information based on the attribute information 41, the promise information 44, the personality information 45, the preference information 46, and the parameter of the agent AG for the income and expenditure type determined as the proposal target.

Specifically, the proposal unit 34 determines the content and the expression method of the proposal information according to a combination of the attribute information 41, the promise information 44, the personality information 45, the preference information 46, and a value of each parameter of the agent AG (a value indicating the content of the information or the parameter).

For example, in a case where the user has made a predetermined promise and the promise has been kept, the proposal unit 34 determines the content of the proposal information to praise that the promise has been kept, such that the promise is continuously kept. At this time, in a case where the user has enough money by keeping the promise (saving money), the proposal unit 34 may propose the proposal information to prompt the user to do what the user likes by using the margin, based on the preference information 46.

In addition, in a case where the promise has not been kept, the proposal unit 34 determines the content of the proposal information to preach about the fact that the promise has not been kept. In this case, the proposal unit 34 changes the expression method of the proposal information according to the personality information 45. For example, the proposal unit 34 adopts an expression method for gently admonishing a user who does not like discipline, and adopts an expression method for strictly disciplining a user who is resistant to discipline.

Furthermore, the proposal unit 34 may change the content and the expression method of the proposal information based on the confidence information indicating the level of confidence in the promise described above or the promise record (record information).

Note that the proposal of the proposal information performed by the proposal unit 34 can be performed at, for example, a predetermined interval (every month) set in advance. Further, the proposal unit 34 may propose the proposal information at an interval shorter than the predetermined interval in the form of an interim report based on the various types of information described above.

For example, the proposal unit 34 may set the interval to be shorter than a set value to frequently propose the proposal information as the interim report including information regarding whether or not the user is likely to keep the promise for the user having many failures in the promise record or the user who is less confident in the promise, and may set the interval to be longer than the set value for the user having many successes in the promise record or the user who is highly confident.

Furthermore, the proposal unit 34 may check the reason why the expenditure is prominently high with respect to the income and expenditure type of which the expenditure is prominently high (is equal to or higher than a predetermined threshold) with the user via the agent AG. For example, the proposal unit 34 may exclude the income and expenditure type from the proposal target in a case where the reason is a temporary unavoidable expenditure (for example, a mobile phone is broken and needs to be replaced) of the user.

Furthermore, the proposal unit 34 may change the content and the expression method of the proposal information according to a prominently high expenditure amount. For example, the proposal unit 34 proposes the proposal information with a stricter tone as the prominently high expenditure amount increases.

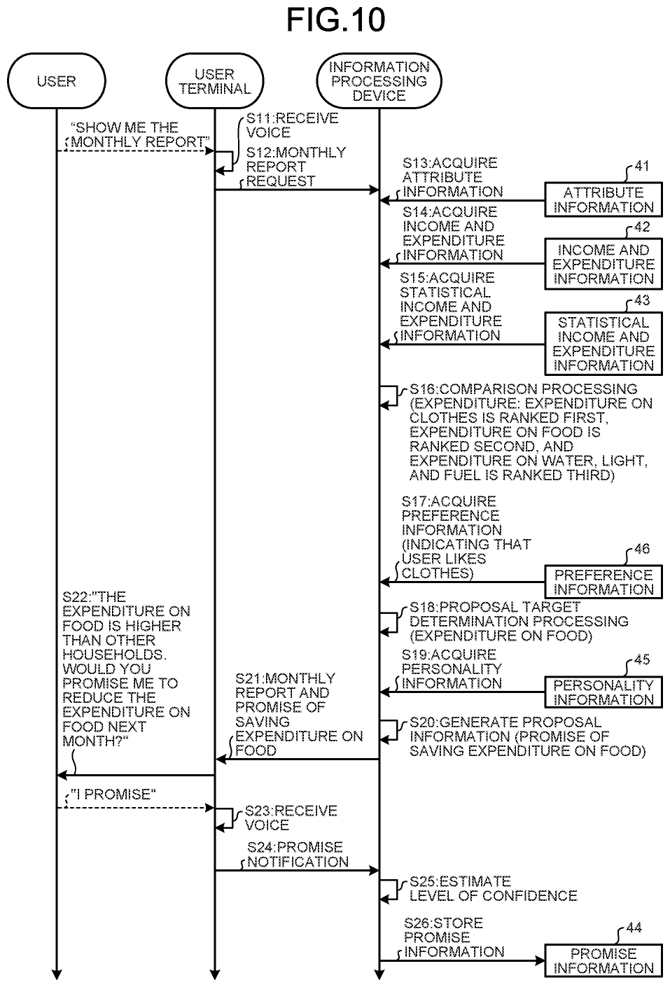

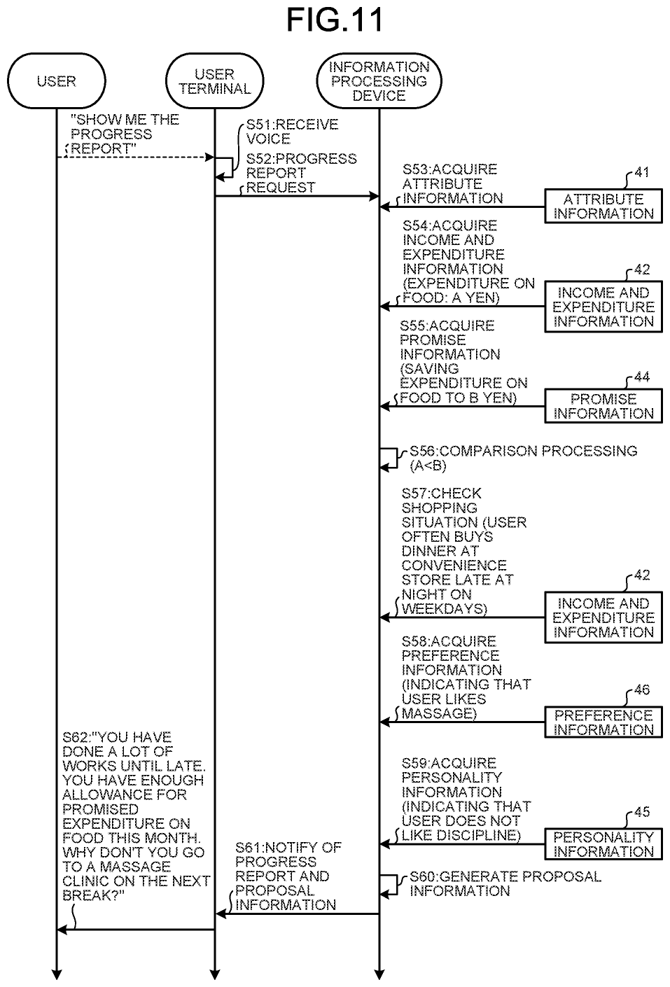

Next, an example of an operation between the user terminal 100 and the information processing device 1 will be described with reference to FIGS. 10 and 11. FIG. 10 is a sequence diagram (Part 1) illustrating the example of the operation between the user terminal 100 and the information processing device 1. FIG. 11 is a sequence diagram (Part 2) illustrating the example of the operation between the user terminal 100 and the information processing device 1.

FIG. 10 illustrates an example of an operation until the promise information 44 is generated, and FIG. 11 illustrates an example of an operation until progress with respect to the promise information 44 is reported.

As illustrated in FIG. 10, first, it is assumed that the user utters “Show me the monthly report” to the user terminal 100. The user terminal 100 receives voice uttered by the user (Step S11).

Subsequently, the user terminal 100 transmits a monthly report (income and expenditure report) request based on the received voice (Step S12), and then the information processing device 1 acquires the attribute information 41 from the storage unit 4 (Step S13).

Subsequently, the information processing device 1 acquires the income and expenditure information 42 from the storage unit 4 (Step S14). Subsequently, the information processing device 1 acquires the statistical income and expenditure information 43 from the storage unit 4 (Step S15).

Subsequently, the information processing device 1 performs processing of comparing the acquired income and expenditure information 42 and the statistical income and expenditure information 43 (Step S16). It is assumed that, as a result of the comparison processing, the expenditure on clothes is ranked first, the expenditure on food is ranked second, and the expenditure on water, light, and fuel is ranked third in descending order of expenditure.

Subsequently, the information processing device 1 acquires the preference information 46 from the storage unit 4 (Step S17). It is assumed that the preference information 46 indicates that the user likes clothes.

Subsequently, the information processing device 1 performs processing of determining the proposal target among the expenditure on clothes, the expenditure on food, and the expenditure on water, light, and fuel based on the preference information 46 (Step S18). Specifically, the information processing device 1 excludes the expenditure on clothes ranked first based on the preference information 46 indicating that the user likes clothes and determines the expenditure on food ranked second as the proposal target.

Subsequently, the information processing device 1 acquires the personality information 45 from the storage unit 4 (Step S19). Subsequently, the information processing device 1 generates the proposal information of which the content (promise of saving the expenditure on food) and the expression method are determined based on the personality information 45 (Step S20).

Subsequently, the information processing device 1 transmits the generated proposal information and the monthly report to the user terminal 100 (Step S21).

Subsequently, the user terminal 100 displays or outputs, by voice, “The expenditure on food is higher than other households. Would you promise me to reduce the expenditure on food next month?”, which is the proposal information, together with the monthly report (Step S22).

Then, it is assumed that the user has uttered “I promise”. The user terminal 100 receives the voice uttered by the user (Step S23). Then, the user terminal 100 makes a promise notification including information regarding the received voice for the information processing device 1 (Step S24).

Subsequently, the information processing device 1 estimates the level of confidence of the user in the promise based on the information included in the promise notification (Step S25). Then, the information processing device 1 generates the promise information 44 including the confidence information indicating the estimated level of confidence and the information regarding the promise, stores the promise information 44 in the storage unit 4 (Step S26), and ends the processing.

Next, the example of the operation between the user terminal 100 and the information processing device 1 illustrated in FIG. 11 will be described.

As illustrated in FIG. 11, it is assumed that the user has uttered “Show me the progress report”. The user terminal 100 receives the voice uttered by the user (Step S51). Subsequently, the user terminal 100 transmits a progress report (income and expenditure report) request to the information processing device 1 based on the received voice (Step S52).

Subsequently, the information processing device 1 acquires the attribute information 41 from the storage unit 4 (Step S53). Subsequently, the information processing device 1 acquires the income and expenditure information 42 from the storage unit 4 (Step S54). Specifically, as the income and expenditure information 42, information regarding expenditure on food of A yen in the middle of the month is acquired.

Subsequently, the information processing device 1 acquires the promise information 44 from the storage unit 4 (Step S55). Specifically, information indicating saving of the expenditure on food for one month to B yen is acquired as the promise information 44.

Subsequently, the information processing device 1 compares the expenditure on food of A yen, which is the income and expenditure information 42, with the expenditure B on food, which is the promise information 44 (Step S56). It is assumed that the comparison result indicates that the expenditure on food of A yen is lower than the expenditure on food of B yen.

Subsequently, the information processing device 1 checks a shopping situation from the income and expenditure information 42 (Step S57). Specifically, it is assumed that it is found from the income and expenditure information 42 that the user often buys dinner at a convenience store late at night on weekdays.

Subsequently, the information processing device 1 acquires, as the preference information 46, information indicating that the user likes a massage from the storage unit 4 (Step S58). Subsequently, the information processing device 1 acquires, as the personality information 45 from the storage unit 4, information indicating that the user does not like discipline (Step S59).

Subsequently, the information processing device 1 generates the proposal information based on the income and expenditure information 42 of Step S57, the preference information 46 of Step S58, and the personality information 45 of Step S59 (Step S60).

Subsequently, the information processing device 1 notifies the user terminal 100 of the progress report and the generated proposal information (Step S61).

Then, the user terminal 100 displays or outputs, by voice, “You have done a lot of works until late. You have enough allowance for promised expenditure on food this month. Why don't you go to a massage clinic on the next break?”, which is the proposal information, together with the progress report (Step S62), and ends the processing.

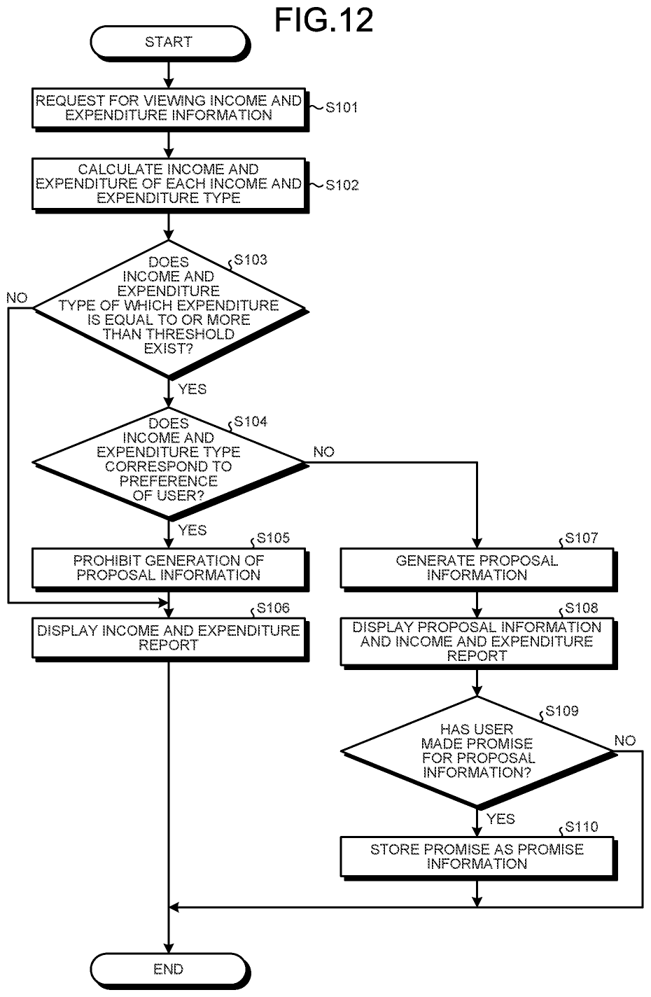

Next, a processing procedure of the processing performed by the information processing device 1 according to the embodiment will be described with reference to FIG. 12. FIG. 12 is a flowchart illustrating the processing procedure of the processing performed by the information processing device 1 according to the embodiment.

As illustrated in FIG. 12, the control unit 3 of the information processing device 1 first receives a request to view the income and expenditure information 42 from the user terminal 100 (Step S101).

Subsequently, the control unit 3 calculates the income and expenditure of each income and expenditure type based on the income and expenditure information 42 stored in the storage unit 4 (Step S102).

Subsequently, the control unit 3 determines whether or not the income and expenditure type of which the expenditure is equal to or more than a predetermined threshold exists among the calculated income and expenditure types (Step S103).

In a case where the income and expenditure type of which the expenditure is equal to or more than the predetermined threshold exists (Step S103: Yes), the control unit 3 determines whether or not the income and expenditure type corresponds to the preference of the user based on the preference information 46 stored in the storage unit 4 (Step S104).

In a case where the income and expenditure type corresponds to the preference of the user (Step S104: Yes), the control unit 3 prohibits generation of the proposal information regarding the income and expenditure type, that is, prohibits the proposal of the proposal information to the user (Step S105).

Subsequently, the control unit 3 transmits the income and expenditure report based on the income and expenditure information 42 to the user terminal 100 to display the income and expenditure report on the user terminal 100 (Step S106), and ends the processing.

On the other hand, in Step S103, in a case where the income and expenditure type of which the expenditure is equal to or more than the predetermined threshold does not exist (Step S103: No), the control unit 3 performs Step S106.

Furthermore, in Step S104, in a case where the income and expenditure type does not correspond to the preference of the user (Step S104: No), the control unit 3 generates the proposal information regarding the income and expenditure type (Step S107).

Subsequently, the control unit 3 transmits the generated proposal information and the income and expenditure report to the user terminal 100 to display the proposal information and the income and expenditure report on the user terminal 100 (Step S108).

Subsequently, the control unit 3 determines whether or not the user has made a promise for the proposal information (Step S109).

In a case where the user has made the promise for the proposal information (Step S109: Yes), that is, in a case where the user promises to carry out the proposal indicated by the proposal information, the control unit 3 stores the promise information 44 in the storage unit 4 (Step S110), and ends the processing.

On the other hand, in Step S109, in a case where the user has not made the promise for the proposal information (Step S109: No), that is, in a case where the user has not promised to carry out the proposal indicated by the proposal information, the control unit 3 ends the processing.

<1-5. Hardware Configuration Example>

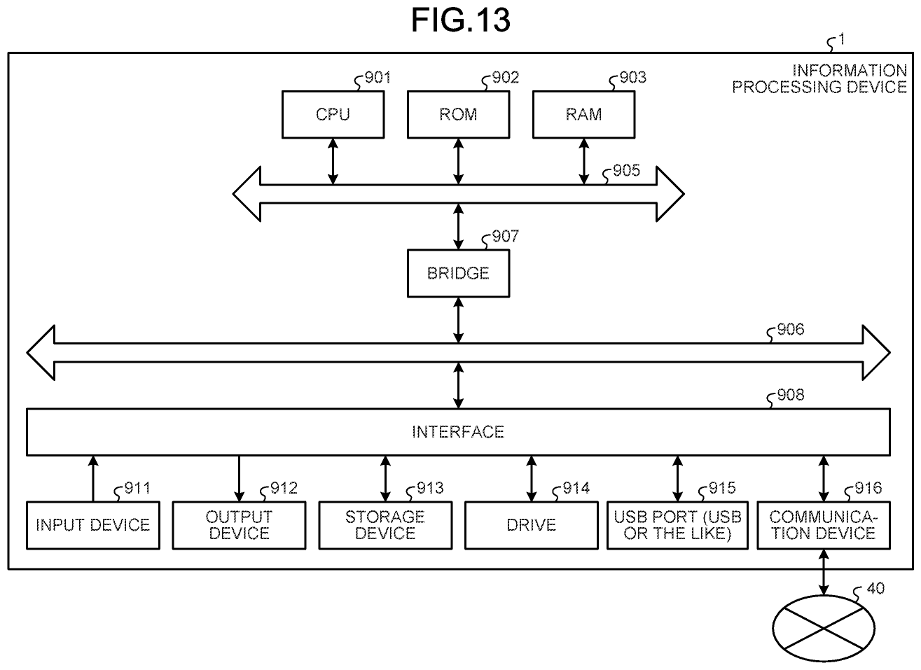

Next, an example of a hardware configuration of the information processing device 1 and the like according to the present embodiment will be described with reference to FIG. 13. FIG. 13 is a block diagram illustrating the example of the hardware configuration of the information processing device 1 according to the present embodiment.

As illustrated in FIG. 13, the information processing device 1 includes a CPU 901, a read only memory (ROM) 902, a RAM 903, a host bus 905, a bridge 907, an external bus 906, an interface 908, an input device 911, an output device 912, a storage device 913, a drive 914, a connection port 915, and a communication device 916. The information processing device 1 may include an electric circuit and a processing circuit such as a digital signal processor (DSP) or an ASIC, instead of or in addition to the CPU 901.

The CPU 901 functions as an operation processing device and a control device, and controls an overall operation in the information processing device 1 according to various programs. Furthermore, the CPU 901 may be a microprocessor. The ROM 902 stores a program, an operation parameter, and the like used by the CPU 901. The RAM 903 temporarily stores a program used in the execution of the CPU 901, a parameter that appropriately changes in the execution, and the like. The CPU 901 may execute, for example, the functions of the collection unit 31, the acquisition unit 32, the setting unit 33, and the proposal unit 34.

The CPU 901, the ROM 902, and the RAM 903 are mutually connected by the host bus 905 including a CPU bus and the like. The host bus 905 is connected to the external bus 906 such as a peripheral component interconnect/interface (PCI) bus via the bridge 907. Note that the host bus 905, the bridge 907, and the external bus 906 do not necessarily have to be separated, and these functions may be implemented by one bus.

The input device 911 is, for example, a device to which information is input by a user, such as a mouse, a keyboard, a touch panel, a button, a microphone, a switch, or a lever. Alternatively, the input device 911 may be a remote control device using infrared rays or other radio waves, or may be an external connection device such as a mobile phone or a PDA corresponding to the operation of the information processing device 1. Furthermore, the input device 911 may include, for example, an input control circuit that generates an input signal based on the information input by the user by using the above input means.

The output device 912 is a device capable of visually or audibly notifying the user of information. The output device 912 may be, for example, a display device such as a cathode ray tube (CRT) display device, a liquid crystal display device, a plasma display device, an electro luminescence (EL) display device, a laser projector, a light emitting diode (LED) projector, or a lamp, or may be a sound output device such as a speaker or a headphone.

The output device 912 may output, for example, results obtained by various types of processing performed by the information processing device 1. Specifically, the output device 912 may visually display the results obtained by various types of processing performed by the information processing device 1 in various formats such as a text, image, table, or graph. Alternatively, the output device 912 may convert an audio signal such as voice data or acoustic data into an analog signal and audibly output the analog signal.

The storage device 913 is a data storage device configured as an example of the storage unit of the information processing device 1. The storage device 913 may be implemented by, for example, a magnetic storage device such as a hard disk drive (HDD), a semiconductor storage device, an optical storage device, or a magneto-optical storage device. Examples of the storage device 913 may include a storage medium, a recording device that records data in a storage medium, a reading device that reads data from a storage medium, a deletion device that deletes data recorded in a storage medium, and the like. The storage device 913 may store a program executed by the CPU 901, various data, various data acquired from the outside, and the like.

The drive 914 is a reader/writer for a storage medium, and is built in or externally attached to the information processing device 1. The drive 914 reads information recorded in a removable storage medium such as a mounted magnetic disk, optical disk, magneto-optical disk, or semiconductor memory, and outputs the information to the RAM 903. Furthermore, the drive 914 can also write information to a removable storage medium.

The connection port 915 is an interface connected to an external device. The connection port 915 is a connection port capable of transmitting data to an external device, and may be, for example, a universal serial bus (USB).

The communication device 916 is, for example, an interface configured by using a communication device or the like for connection to a network 40. The communication device 916 may be, for example, a communication card for wired or wireless local area network (LAN), long term evolution (LTE), Bluetooth (registered trademark), wireless USB (WUSB), or the like. Further, the communication device 916 may be a router for optical communication, a router for asymmetric digital subscriber line (ADSL), a modem for various types of communication, or the like. The communication device 916 can transmit and receive a signal and the like to and from, for example, the Internet or another communication device in accordance with a predetermined protocol such as TCP/IP.

Note that the network 40 is a wired or wireless information transmission path. For example, the network 40 may include a public line network such as the Internet, a telephone line network, or a satellite communication network, various local area networks (LAN) including Ethernet (registered trademark), a wide area network (WAN), or the like. In addition, the network 40 may include a dedicated line network such as an Internet protocol-virtual private network (IP-VPN).

Note that it is also possible to create a computer program for causing hardware such as a CPU, a ROM, and a RAM built in the information processing device 1 to implement functions equivalent to the respective configurations of the information processing device 1 according to the present embodiment described above. Furthermore, a storage medium storing the computer program can also be provided.

As described above, the preferred embodiments of the present disclosure have been described in detail with reference to the accompanying drawings, but the technical scope of the present disclosure is not limited to such examples. It is obvious that a person with an ordinary skill in a technological field of the present disclosure could conceive of various modifications or corrections within the scope of the technical ideas described in the appended claims, and it should be understood that such modifications or corrections also fall within the technical scope of the present disclosure.

Furthermore, the effects described in the present specification are merely illustrative or exemplary and are not restrictive. That is, the technology according to the present disclosure can exhibit, in addition to or in place of the above-described effects, other effects obvious to those skilled in the art from the description of the present specification.

### 2. Modified Example

Further, the information processing program may be stored in a disk device included in a server device on a network such as the Internet, and be downloaded to a computer. Further, the functions described above may be implemented by cooperation between an operating system (OS) and application software. In this case, the part other than the OS may be stored in a medium and distributed, or the part other than the OS may be stored in the server device and downloaded to a computer.

Further, among the respective processing described in the above-described embodiments, all or some of the processing described as being automatically performed can be manually performed. Alternatively, all or some of the processing described as being manually performed can be automatically performed by a known method. In addition, the processing procedures, specific names, information including various data and parameters illustrated in the specification and drawings can be arbitrarily changed unless otherwise specified. For example, various types of information illustrated in each drawing is not limited to the illustrated information.

Further, each illustrated component of each device is functionally conceptual, and does not necessarily have to be configured physically as illustrated in the drawings. That is, the specific modes of distribution/integration of the respective devices are not limited to those illustrated in the drawings. All or some of the devices can be functionally or physically distributed/integrated in any arbitrary unit, depending on various loads or the status of use.

Further, the above-described embodiments can be appropriately combined as long as the processing contents do not contradict each other. Further, the order of the steps illustrated in the flowchart or the sequence diagram of the above-described embodiments can be changed as appropriate.

### 3. Conclusion

As described above, according to an embodiment of the present disclosure, the information processing device 1 according to the present embodiment includes the collection unit 31, the acquisition unit 32, and the proposal unit 34. The collection unit 31 collects the income and expenditure information 42 regarding the income and expenditure of the user. The acquisition unit 32 acquires the promise information 44 of the promise regarding the income and expenditure made by the user with the agent AG (virtual entity) displayed on the display unit of the user terminal 100 (terminal device) possessed by the user. The proposal unit 34 proposes predetermined proposal information regarding the income and expenditure to the user based on the income and expenditure information 42 and the promise information 44.

As a result, a more appropriate proposal can be made to the user.

In addition, the proposal unit 34 determines the content and the expression method of the proposal information based on the income and expenditure information 42 and the promise information 44.

As a result, it is possible to make a proposal to the user with a more appropriate content and expression method.

Furthermore, the acquisition unit 32 further acquires the preference information 46 regarding the preference of the user. The proposal unit 34 determines an income and expenditure type for which the proposal information is to be proposed based on the preference information 46 among the income and expenditure types included in the income and expenditure information 42.

As a result, it is possible to make a proposal in consideration of the preference of the user, and thus, it is possible to make a proposal that is easy for the user to accept, such that the degree of satisfaction of the user with the proposal can be improved.

The proposal unit 34 prohibits the proposal of the proposal information for the income and expenditure type corresponding to the preference information 46 among the income and expenditure types included in the income and expenditure information 42.

As a result, no proposal is made regarding the income and expenditure on what the user likes or the like, such that the degree of satisfaction of the user with the proposal can be improved.

Furthermore, the acquisition unit 32 further acquires the personality information 45 regarding the personality of the user. The proposal unit 34 proposes the proposal information based on the personality information 45.

As a result, it is possible to make a proposal in consideration of the personality of the user, and thus, it is possible to make a proposal that is easy for the user to accept, such that the degree of satisfaction of the user with the proposal can be improved.

The acquisition unit 32 acquires a reaction of the user to the proposal information, and acquires, as the personality information 45, the personality estimated based on the acquired reaction.

As a result, it is possible to acquire more accurate personality information 45 of the user.

In addition, the acquisition unit 32 acquires the promise information 44 indicating that the user promises to carry out the proposal indicated by the proposal information proposed by the proposal unit 34.

As a result, the user makes a promise for the proposed content, such that the user can reliably grasp a content of the promise.

The acquisition unit 32 further acquires the record information regarding the record of success and failure for the past promise information 44. The proposal unit 34 proposes the proposal information based on the record information.

As a result, for example, it is possible to propose the proposal information for which the user is likely to make a promise with a high possibility of success.

The acquisition unit 32 acquires the promise information 44 including the confidence information indicating the level of confidence of the user in the promise, the level of confidence being estimated based on information input via the user terminal 100. The proposal unit 34 proposes the proposal information based on the confidence information.

As a result, it is possible to make a proposal in consideration of the level of confidence of the user at the time of making a promise.

The collection unit 31 acquires the income and expenditure information 42 including at least one piece of information of an article type related to the income and expenditure, an income and expenditure amount, the number of times of occurrence of the income and expenditure, a date and time when the income and expenditure has occurred, or a place where the income and expenditure has occurred.

As a result, the more detailed income and expenditure information 42 can be acquired, such that the proposal information from the proposal unit 34 can be made more accurate.

The collection unit 31 acquires, as the income and expenditure information 42, information regarding the difference between the income and expenditure information 42 in the current predetermined period and the income and expenditure information 42 in the past predetermined period.

As a result, the proposal unit 34 can make a proposal in consideration of the difference in income and expenditure information 42 between the present and the past.

Furthermore, the acquisition unit 32 further acquires the attribute information 41 of the user. The proposal unit 34 proposes the proposal information based on a result of comparison between the income and expenditure information 42 of another user having similar attribute information 41 and the income and expenditure information 42 of the user.

As a result, it is possible to make a proposal based on a result of comparison with another user having a similar attribute.

Furthermore, the information processing device 1 further includes the setting unit 33 that sets a personality of the agent AG based on information input from the user via the user terminal 100. The proposal unit 34 proposes the proposal information based on the personality of the agent AG set by the setting unit 33.

As a result, the user can make a conversation with the agent AG having a predetermined personality, such that, for example, the proposal information from an inorganic agent can be more easily accepted by the user.

Although the respective embodiments of the present disclosure have been described above, the technical scope of the present disclosure is not limited to the above-described embodiments, and various modifications can be made without departing from the scope of the present disclosure. Moreover, the components of different embodiments and modified examples may be appropriately combined.

Further, the effects in each embodiment described in the present specification are merely examples. The effects of the present disclosure are not limited thereto, and other effects may be obtained.

Note that the present technology can also have the following configurations.

(1)

An information processing device comprising:

a collection unit that collects income and expenditure information regarding income and expenditure of a user;

an acquisition unit that acquires promise information of a promise regarding the income and expenditure made by the user with a virtual entity displayed on a display unit of a terminal device possessed by the user; and

a proposal unit that proposes predetermined proposal information regarding the income and expenditure to the user based on the income and expenditure information and the promise information.

(2)

The information processing device according to the above-described (1), wherein

the proposal unit determines a content and an expression method of the proposal information based on the income and expenditure information and the promise information.

(3)

The information processing device according to the above-described (1) to (2), wherein

the acquisition unit further acquires preference information regarding a preference of the user, and

the proposal unit determines an income and expenditure type for which the proposal information is to be proposed based on the preference information, among income and expenditure types included in the income and expenditure information.

(4)

The information processing device according to the above-described (3), wherein

the proposal unit prohibits the proposal of the proposal information for the income and expenditure type corresponding to the preference information among the income and expenditure types included in the income and expenditure information.

(5)

The information processing device according to the above-described (1) to (4), wherein

the acquisition unit further acquires personality information regarding a personality of the user, and

the proposal unit proposes the proposal information based on the personality information.

(6)

The information processing device according to the above-described (5), wherein

the acquisition unit acquires a reaction of the user to the proposal information, and acquires, as the personality information, the personality estimated based on the acquired reaction.

(7)

The information processing device according to the above-described (1) to (6), wherein

the acquisition unit acquires the promise information indicating that the user promises to carry out a proposal indicated by the proposal information proposed by the proposal unit.

(8)

The information processing device according to the above-described (1) to (7), wherein

the acquisition unit further acquires record information regarding a record of success and failure for past promise information, and

the proposal unit proposes the proposal information based on the record information.

(9)

The information processing device according to the above-described (1) to (8), wherein

the acquisition unit acquires the promise information including confidence information indicating a level of confidence of the user in the promise, the level of confidence being estimated based on information input via the terminal device, and

the proposal unit proposes the proposal information based on the confidence information.

(10)

The information processing device according to the above-described (1) to (9), wherein

the collection unit acquires the income and expenditure information including at least one piece of information of an article type related to the income and expenditure, an income and expenditure amount, a frequency of occurrence of the income and expenditure, a date and time when the income and expenditure has occurred, or a place where the income and expenditure has occurred.

(11)

The information processing device according to the above-described (1) to (10), wherein

the collection unit acquires, as the income and expenditure information, information regarding a difference between the income and expenditure information in a current predetermined period and the income and expenditure information in a past predetermined period.

(12)

The information processing device according to the above-described (1) to (11), wherein

the acquisition unit further acquires attribute information of the user, and

the proposal unit proposes the proposal information based on a result of comparison between the income and expenditure information of another user having similar attribute information and the income and expenditure information of the user.

(13)

The information processing device according to the above-described (1) to (12), further comprising

a setting unit that sets a personality of the virtual entity based on information input from the user via the terminal device, wherein

the proposal unit proposes the proposal information based on the personality of the virtual entity set by the setting unit.

(14)

An information processing method comprising:

a collection step of collecting income and expenditure information regarding income and expenditure of a user;

an acquisition step of acquiring promise information of a promise regarding the income and expenditure made by the user with a virtual entity displayed on a display unit of a terminal device possessed by the user; and

a proposal step of proposing predetermined proposal information regarding the income and expenditure to the user based on the income and expenditure information and the promise information.

(15)

An information processing program causing a computer to perform:

a collection procedure of collecting income and expenditure information regarding income and expenditure of a user;

an acquisition procedure of acquiring promise information of a promise regarding the income and expenditure made by the user with a virtual entity displayed on a display unit of a terminal device possessed by the user; and

a proposal procedure of proposing predetermined proposal information regarding the income and expenditure to the user based on the income and expenditure information and the promise information.

### REFERENCE SIGNS LIST

1 INFORMATION PROCESSING DEVICE
2 COMMUNICATION UNIT
3 CONTROL UNIT
4 STORAGE UNIT
31 COLLECTION UNIT
32 ACQUISITION UNIT
33 SETTING UNIT
34 PROPOSAL UNIT
100 USER TERMINAL
200 COMMUNICATION UNIT
300 CONTROL UNIT
400 STORAGE UNIT
AG AGENT

1. An information processing device comprising:
a collection unit that collects income and expenditure information regarding income and expenditure of a user;
an acquisition unit that acquires promise information of a promise regarding the income and expenditure made by the user with a virtual entity displayed on a display unit of a terminal device possessed by the user; and
a proposal unit that proposes predetermined proposal information regarding the income and expenditure to the user based on the income and expenditure information and the promise information.

2. The information processing device according to claim 1, wherein
the proposal unit determines a content and an expression method of the proposal information based on the income and expenditure information and the promise information.

3. The information processing device according to claim 1, wherein
the acquisition unit further acquires preference information regarding a preference of the user, and
the proposal unit determines an income and expenditure type for which the proposal information is to be proposed based on the preference information, among income and expenditure types included in the income and expenditure information.

4. The information processing device according to claim 3, wherein
the proposal unit prohibits the proposal of the proposal information for the income and expenditure type corresponding to the preference information among the income and expenditure types included in the income and expenditure information.

5. The information processing device according to claim 1, wherein
the acquisition unit further acquires personality information regarding a personality of the user, and
the proposal unit proposes the proposal information based on the personality information.

6. The information processing device according to claim 5, wherein
the acquisition unit acquires a reaction of the user to the proposal information, and acquires, as the personality information, the personality estimated based on the acquired reaction.

7. The information processing device according to claim 1, wherein
the acquisition unit acquires the promise information indicating that the user promises to carry out a proposal indicated by the proposal information proposed by the proposal unit.

8. The information processing device according to claim 1, wherein
the acquisition unit further acquires record information regarding a record of success and failure for past promise information, and
the proposal unit proposes the proposal information based on the record information.

9. The information processing device according to claim 1, wherein
the acquisition unit acquires the promise information including confidence information indicating a level of confidence of the user in the promise, the level of confidence being estimated based on information input via the terminal device, and
the proposal unit proposes the proposal information based on the confidence information.

10. The information processing device according to claim 1, wherein
the collection unit acquires the income and expenditure information including at least one piece of information of an article type related to the income and expenditure, an income and expenditure amount, a frequency of occurrence of the income and expenditure, a date and time when the income and expenditure has occurred, or a place where the income and expenditure has occurred.

11. The information processing device according to claim 1, wherein
the collection unit acquires, as the income and expenditure information, information regarding a difference between the income and expenditure information in a current predetermined period and the income and expenditure information in a past predetermined period.

12. The information processing device according to claim 1, wherein
the acquisition unit further acquires attribute information of the user, and
the proposal unit proposes the proposal information based on a result of comparison between the income and expenditure information of another user having similar attribute information and the income and expenditure information of the user.

13. The information processing device according to claim 1, further comprising
a setting unit that sets a personality of the virtual entity based on information input from the user via the terminal device, wherein
the proposal unit proposes the proposal information based on the personality of the virtual entity set by the setting unit.

14. An information processing method comprising:
a collection step of collecting income and expenditure information regarding income and expenditure of a user;
an acquisition step of acquiring promise information of a promise regarding the income and expenditure made by the user with a virtual entity displayed on a display unit of a terminal device possessed by the user; and
a proposal step of proposing predetermined proposal information regarding the income and expenditure to the user based on the income and expenditure information and the promise information.

15. An information processing program causing a computer to perform:
a collection procedure of collecting income and expenditure information regarding income and expenditure of a user;
an acquisition procedure of acquiring promise information of a promise regarding the income and expenditure made by the user with a virtual entity displayed on a display unit of a terminal device possessed by the user; and
a proposal procedure of proposing predetermined proposal information regarding the income and expenditure to the user based on the income and expenditure information and the promise information.
